(19) United States
(12) Patent Application Publication
(10) Pub. No.: US 2025/0392375 A1
(43) Pub. Date: Dec. 25, 2025

(54) SATELLITE ANTENNA WITH ADJACENT SATELLITE INTERFERENCE EXCLUSION FUNCTION AND ITS OPERATING METHOD

(71) Applicant: KNS INC., Daejeon (KR)

(72) Inventors: BYEONG WOOK JIN, Daejeon (KR); GIL SANG RYU, Daejeon (KR); YOUNG SUN KIM, Daejeon (KR)

(21) Appl. No.: 18/795,380

(22) Filed: Aug. 6, 2024

(30) Foreign Application Priority Data
Jun. 25, 2024 (KR) 10-2024-0082981

(51) Int. Cl. H04B 7/185; H01Q 3/04

(52) U.S. Cl. CPC H04B 7/18519; H01Q 3/04; H04B 7/18513; H04B 7/18515; H04B 7/1858

(57) ABSTRACT

A satellite antenna has a function for excluding adjacent satellite interference. The satellite antenna according to an embodiment includes an antenna unit for receiving a signal from a satellite, an signal-to-noise ratio (SNR) calculation unit configured to calculate a signal-to-noise ratio (SNR) for a satellite signal received by the antenna unit, and a signal selection unit configured to compare signal-to-noise ratios calculated by the SNR calculation unit for satellite signals from a multiple number of satellites and select one satellite signal.

### CROSS-REFERENCE TO RELATED APPLICATION AND CLAIM OF PRIORITY

The present application claims the benefit of Korean Patent Application No. 10-2024-0082981, filed on Jun. 25, 2024 at the Korean Intellectual Property Office, the disclosure of which is incorporated herein by reference in its entirety.

### BACKGROUND

### 1. Technical Field

The present invention relates to a satellite antenna having a function for excluding adjacent satellite interference and to an operating method of the satellite antenna.

### 2. Description of the Related Art

The adjacent satellite interference (ASI) phenomenon occurs when adjacent satellites use similar frequency bands, as the communications signals of the satellites affect each other and cause problems in communication. A small antenna mounted with a reflection plate of 40 cm or smaller is particularly vulnerable to this problem, and this phenomenon occurs with a high probability, with the beam pattern becoming broadened and the directionality becoming lowered during the reception of the satellite signals. In the case of the Koreasat 5A and Koreasat 6 satellites of South Korea, the two satellites are positioned at close longitudes and are operated at the same frequency bands, and the signals of Koreasat 6 are 6˜7 dB higher than the signals of Koreasat 5A, resulting in an environment in which significant interference may occur in the satellite tracking of Koreasat 5A.

The conventional tracking method is based on searching for the satellite having the greatest signal strength at a particular operating frequency, so that even when Koreasat 5A is targeted, for example, there is the problem that the Koreasat 6 satellite having the greater signal strength is recognized mistakenly due to their operating under the same frequency.

Since such a problem occurs more often with smaller antennas having broader beam patterns, this is an important point of consideration in designing and operating a satellite communication system that employs a small antenna.

### SUMMARY

An aspect of the present invention, which was conceived to resolve the problem described above, is to provide a satellite antenna having a function for excluding adjacent satellite interference and an operating method of the satellite antenna that allow a more accurate tracking of a desired satellite signal.

Other objectives of the present invention will be more clearly understood from the embodiments set forth below.

One aspect of the invention provides a satellite antenna having a function for excluding adjacent satellite interference, where the satellite antenna includes: an antenna unit for receiving a signal from a satellite; an SNR calculation unit configured to calculate a signal-to-noise ratio (SNR) for a satellite signal received by the antenna unit; and a signal selection unit configured to compare signal-to-noise ratios calculated by the SNR calculation unit for satellite signals from a multiple number of satellites and select one satellite signal.

Here, the signal selection unit can select the satellite signal having the highest signal-to-noise ratio.

Also, the satellite antenna can further include a rotation control unit that is configured to control a direction of the antenna unit, where the signal selection unit can control the rotation control unit to rotate the antenna unit if a result of comparing the signal-to-noise ratios yields a difference smaller than a threshold value.

Also, the signal selection unit can sequentially rotate the antenna unit in predetermined directions within a particular angle and can ultimately select the satellite signal having the highest signal-to-noise ratio with a difference greater than or equal to the threshold value.

Also, the signal selection unit can determine the sequence of the directions based on a target satellite aimed for detection and a predicted surrounding satellite.

Also, the signal selection unit can control the rotation control unit to rotate the antenna unit again to a direction with which the signal strength of the selected satellite signal was the strongest.

Also, the threshold value can be set in accordance with the highest signal-to-noise ratio value.

In another aspect of the invention, the antenna unit can further include: a directional antenna unit for receiving a satellite signal having the highest signal-to-noise ratio; and an omnidirectional antenna unit for receiving signals including a multiple number of satellite signals.

Here, the antenna unit can further include: a noise generation unit configured to generate an ambient noise signal by subtracting a satellite signal received at the directional antenna unit from a surrounding signal including a satellite signal received at the omnidirectional antenna unit; and a noise removal unit configured to generate a satellite signal with noise removed by subtracting the ambient noise signal from the satellite signal received at the directional antenna unit.

Another aspect of the invention provides an operating method of a function for excluding adjacent satellite interference, where the operating method is performed at a satellite antenna and includes: receiving satellite signals from a plurality of satellites; calculating signal-to-noise ratios for the received satellite signals; and selecting a satellite signal based on a comparison of the calculated signal-to-noise ratios.

Here, the operating method can further include: rotating an antenna if a comparison result of the signal-to-noise ratios yields a difference smaller than a threshold value.

According to an embodiment of the invention, a function for excluding adjacent satellite interference can be utilized to more accurately search and track a desired satellite signal.

Other aspects, features, and advantages would be more clearly understood from the drawings, claims, and detailed description of the invention set forth below.

### BRIEF DESCRIPTION OF THE DRAWINGS

FIG. 1 is a block diagram illustrating the composition of a satellite antenna having a function for excluding adjacent satellite interference according to an embodiment of the invention.

FIG. 2 illustrates examples of the degrees of directionality exhibited by different antennas.

FIG. 3 illustrates an overlap of satellite signals.

FIG. 4 is a flow diagram illustrating the overall operating process of a function for excluding adjacent satellite interference according to an embodiment of the invention.

FIG. 5 is a flow diagram illustrating the process of a function for excluding adjacent satellite interference by using antenna rotation according to an embodiment of the invention.

FIG. 6 is a flow diagram illustrating the tracking process after the selecting of a satellite signal based on antenna rotation according to an embodiment of the invention.

### DETAILED DESCRIPTION OF THE INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed by the present invention.

When a component is mentioned as being “coupled” or “connected” to another component, this may mean that the component is directly coupled or connected to the other component or may mean that they are coupled or connected with still another component in-between. On the other hand, if a component is mentioned as being “directly coupled” or “directly connected” to another component, this should be understood as meaning that there are no other components between the mentioned components.

While such terms as “first” and “second,” etc., can be used to describe various components, such components are not to be limited by the above terms. The above terms are used only to distinguish one component from another. For example, terms such as a first threshold value, a second threshold value, etc., used below may refer to threshold values that are pre-designated to be substantially different or partially the same. Since there is a risk of confusion arising if these concepts were to be referred to by the same term “threshold value”, the ordinal numbers first, second, etc., are added to more easily differentiate the concepts.

The terms used in the present specification are merely used to describe particular embodiments and are not intended to limit the present invention. An expression used in the singular encompasses the expression of the plural, unless it has a clearly different meaning in the context. In the present specification, it is to be understood that terms such as “including” or “having,” etc., are intended to indicate the existence of the features, numbers, steps, actions, components, parts, or combinations thereof disclosed in the specification and are not intended to preclude the possibility that one or more other features, numbers, steps, actions, components, parts, or combinations thereof may exist or may be added.

Also, the components of an embodiment described with reference to each drawing are not necessarily applied exclusively to the corresponding embodiment and can be implemented so as to be included in another embodiment as long as the spirit of the invention is maintained. Moreover, is should be appreciated that multiple embodiments can be implemented as a single combined embodiment, even though it is not expressly stated as such.

In describing the appended drawings, the same components are assigned the same or related reference numerals regardless of the figure number, and redundant explanations are omitted. In the description of the present invention, certain detailed explanations of the related art are omitted if it is deemed that they may unnecessarily obscure the essence of the invention.

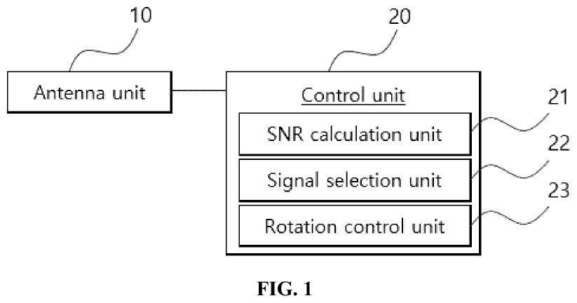

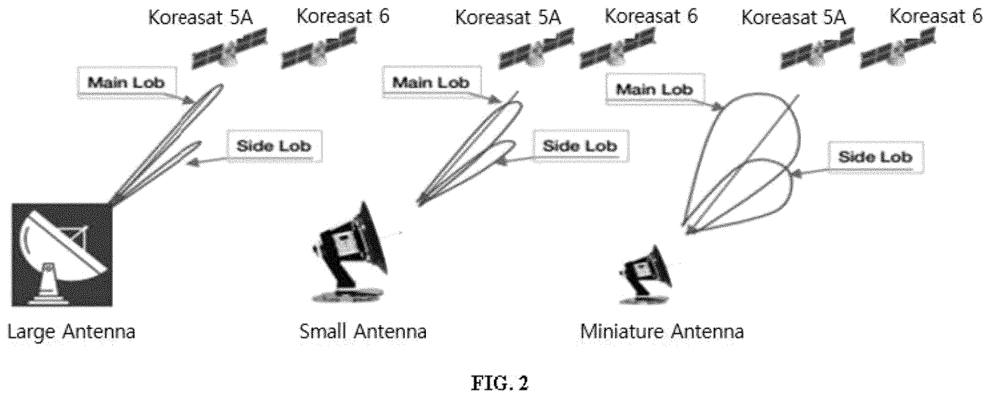

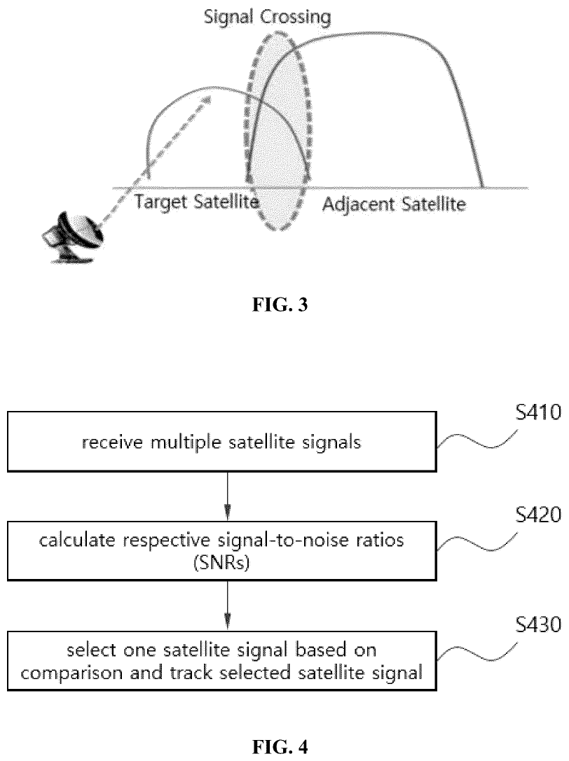

FIG. 1 is a block diagram illustrating the composition of a satellite antenna having a function for excluding adjacent satellite interference according to an embodiment of the invention, FIG. 2 illustrates examples of the degrees of directionality exhibited by different antennas, and FIG. 3 illustrates an overlap of satellite signals. Referring to FIG. 1, a satellite antenna according to this embodiment can include an antenna unit 10 and a control unit 20, where the control unit 20 can include an SNR calculation unit 21, a signal selection unit 22, and a rotation control unit 23.

To provide an overview of a satellite antenna system, a satellite antenna system may track a satellite through signal recognition and stabilization functions, and the control unit of the antenna may transfer information associated with the navigation of the ship and the satellite inertia to the satellite antenna. The user can use a modem to receive emergency and aid requests and broadcasts or access telephone or Internet communications.

The satellite antenna system may include an upper radome, a lower radome, an antenna, a pedestal control unit (PCU), an inertial measurement unit (IMU), a multi-RF unit (MRU), and a pedestal. The upper radome can protect the equipment from elements of the ocean environment, while the lower radome can protect the equipment from elements of the ocean environment and be secured to the pedestal and the body of the ship. The antenna, for which a dish-shaped parabolic antenna is typically used, is a structure for collecting or transmitting satellite signals, the PCU is a device that searches and tracks the antenna, the IMU is used to check inertia information, the MRU is a device that processes analog and digital signals received from the satellite, and the pedestal is a mechanical structure that supports the antenna and allows movement in a desired direction along each axis.

The antenna unit 10 may include the antenna and thus may receive signals from the satellite. The antenna unit 10, equipped with a reflector plate, etc., is well known to the skilled person, and as such, further detailed descriptions are omitted here. Referring to FIG. 2 and FIG. 3, however, a large antenna may have a narrow beam pattern and therefore may have high directionality, whereas a small antenna may have a broad beam pattern, which may result in crossed signals due to an overlap of satellite signals, as illustrated in FIG. 3.

To address this problem, the present embodiment utilizes the signal-to-noise ratio (SNR) of each satellite signal.

The SNR calculation unit 21 of the control unit 20 may calculate the signal-to-noise ratio (SNR) for a received satellite signal. The signal-to-noise ratio is defined as <Equation 1> shown below.

$$SNR = Ps / Pn , \qquad < Equation 1 >$$

where Ps and Pn correspond to the power values of the signal (signal strength) and the noise, respectively. By regarding the strength of the signal power as a ratio of the noise power, the relative magnitude of the signal power can be represented. This is because the performance of a communication signal is determined not by the absolute signal power but by the power of the signal in relation to the noise power. Other measures of the performance of a communication system include the channel capacity, which is the maximum achievable capacity, the error rate, which represents the degree of reliability, the delay rate, which represents how naturally a transmission is made, and others.

When signals from an operating satellite (target satellite) and a geographically close adjacent satellite are received overlapping the same band, a crossing of signals may occur, leading to an error in precision tracking. Therefore, when multiple sets of satellite signals are thus received, the SNR of each signal may be calculated.

The signal selection unit 22 of the control unit 20 may compare the signal-to-noise ratios for the satellite signals of the multiple satellites as calculated by the SNR calculation unit 21 and select a satellite signal. For example, the signal selection unit 22 may select the satellite signal having the highest signal-to-noise ratio. That is, whereas conventional methods select the signal with the greatest signal strength, the present embodiment may select the satellite signal having the higher signal-to-noise ratio. For example, with a conventional system that utilizes signal strength, targeting Koreasat 5A may still cause the system to mistakenly recognize Koreasat 6, which has a stronger signal, due to their operating under the same frequency. However, with the present embodiment, targeting Koreasat 5A would yield a higher signal-to-noise ratio, allowing the system to correctly search and track the targeted satellite signal.

In one example, the control unit 20 may further include a rotation control unit 23 that controls the direction (elevation angle, azimuth angle, left and right inclination angles, etc.) of the antenna unit 10, and the signal selection unit 22 may control the rotation control unit 23 to rotate the antenna unit 10 if the result of comparing the signal-to-noise ratios yields a difference that is smaller than a threshold value.

For example, if two satellite signals are detected but the difference between the two SNR values is smaller than the threshold value, there is a possibility of incorrect detection. Thus, in such cases, the targeting direction of the antenna may be adjusted, so that the satellite signal having an SNR value that is greater by a difference tantamount to or exceeding the threshold value may ultimately be selected.

Thus, the signal selection unit 22 may sequentially rotate the antenna unit 10 in predetermined directions within a certain angle and ultimately select the satellite signal with the highest signal-to-noise ratio having a difference greater than or equal to the threshold value. Here, the sequence of the direction can be determined based on the target satellite aimed for detection and the predicted surrounding satellites. For example, the rotational direction of higher priority may be determined by using the movement path of the target satellite, the surrounding satellites corresponding to the current time and their movement paths, etc. Considering an example to further aid understanding, if the target satellite moves from the left towards the right with respect to a viewing direction, and an identified surrounding satellite moves from the top towards the bottom, then the rotational direction of [left to right] may be given higher priority, while the left and right inclination angle, up-to-down direction may be given sequentially lower priorities.

The following provides a more detailed description of the process for the function for excluding adjacent satellite interference.

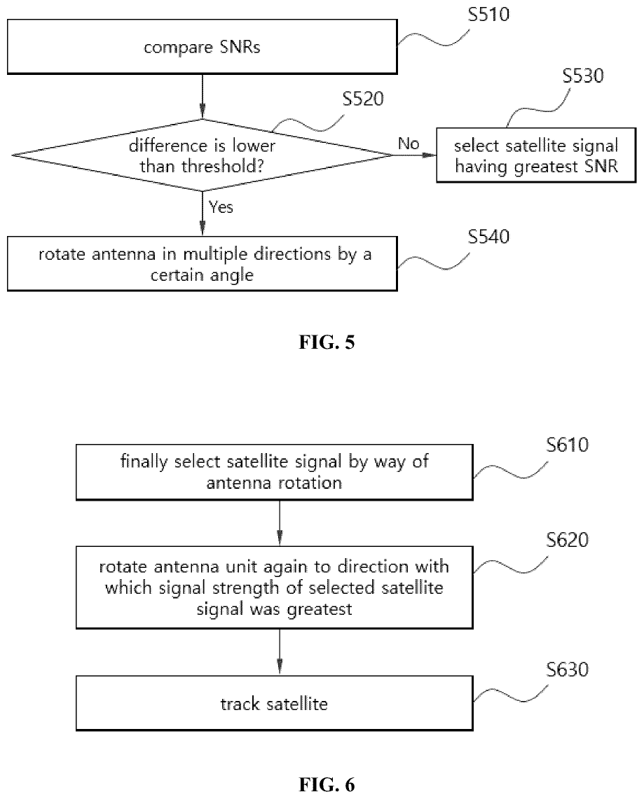

FIG. 4 is a flow diagram illustrating the overall operating process of a function for excluding adjacent satellite interference according to an embodiment of the invention, and FIG. 5 is a flow diagram illustrating the process of a function for excluding adjacent satellite interference by using antenna rotation according to an embodiment of the invention.

Referring first to FIG. 4, in searching for the satellite signal for a target satellite, if satellite signals are received from a multiple number of satellites (S410), then the signal-to-noise ratio (SNR) may be calculated for each of the received satellite signals (S420).

Based on a comparison of the calculated signal-to-noise ratios, a satellite signal may be selected, and the satellite signal may be tracked (S430). For example, the satellite signal having the maximum signal-to-noise ratio (SNR) may be selected and tracked.

Referring to the example shown in FIG. 5, operation S430 may include comparing the calculated SNR values (S510) and determining whether or not the comparison result is a difference that is less than the threshold value (S520). This may determine, for example, whether or not two interfering satellite signals have very similar or identical signal-to-noise ratios and thereby reduce erroneous detection.

If there is a difference tantamount to the threshold value or greater, this would indicate a high probability of correct detection, and thus the satellite signal having the strongest signal-to-noise ratio may be selected and tracked (S530).

If, in contrast, the difference is smaller than the threshold value, the antenna may be rotated sequentially along each direction within a particular angle (S540) for a more accurate detection, and it may be determined whether or not the difference in the newly calculated SNR values are greater than or equal to the threshold value (S510). As described above, the sequence of the directions can be determined based on the target satellite aimed at for detection and the predicted surrounding satellites.

According to another embodiment of the invention, the antenna unit can further include a directional antenna unit for receiving a satellite signal and an omnidirectional antenna unit for receiving surrounding signals including the satellite signal.

The directional antenna unit for receiving satellite signals can be provided mainly to receive the signals of a particular satellite. The directional antenna unit may further include, for example, a Cassegrain antenna or a parabolic antenna to receive signals with a focus on satellite signals that are transmitted in a particular direction.

The omnidirectional antenna unit can receive signals over all directions without directionality. The omnidirectional antenna unit can include, for example, a coil antenna, a helical antenna, or a dipole antenna. The waves received by the omnidirectional antenna unit can include signals transmitted by not only a specific satellite but also various satellites as well as the electromagnetic noise from the surrounding environment.

Also, the antenna unit can further include a noise generation unit, which may generate an ambient noise signal by subtracting the satellite signal received at the directional antenna unit from the surrounding signals including the satellite signal received at the omnidirectional antenna unit, and a noise removal unit, which may generate a satellite signal with the noise removed by subtracting the ambient noise signal from the satellite signal received at the directional antenna unit.

The satellite signal received at the directional antenna unit can include the surrounding noise. Therefore, when the satellite signal received at the directional antenna unit is modulated, the noise can be modulated as well, causing a reduction in the signal-to-noise ratio or an amplification of the noise. To prevent this, the waves received at the omnidirectional antenna unit may be subtracted, so as to leave only the satellite signal associated with the desired satellite and remove noise, and thereby improve the performance of the satellite signal modulation.

FIG. 6 is a flow diagram illustrating the tracking process after the selecting of a satellite signal based on antenna rotation according to an embodiment of the invention.

Referring to FIG. 6, when the final selection of the target satellite based on rotating the antenna and comparing SNR values is completed (S610) in accordance with the embodiment illustrated in FIG. 5, then the antenna unit 10 may be rotated again to the direction with which the signal strength of the selected satellite signal was the strongest (S620). That is, the direction with which the measured signal strength of the target satellite is the strongest may be checked during the rotation, and the antenna may be positioned to this direction. Here, it is also possible to select the direction with which not only the signal strength but also the SNR was the highest. For example, the antenna unit 10 may be positioned to the direction with which the value of [signal strength*signal-to-noise ratio] was measured to be the highest.

When the rotation is completed, the tracking of the satellite may begin (S630).

According to this embodiment, the history of the antenna directions obtained during the rotation for the adjacent satellite interference exclusion function can be utilized in searching and tracking the optimal direction, so that the satellite signals may be received with greater clarity.

According to another embodiment of the invention, an antenna based on the invention can perform a nutation operation. A nutation operation can involve a swaying or nodding action with respect to an axis of rotation. That is, the motion of an antenna based on the invention searching for a satellite signal can involve not only simply following a circular path in the air but can also involve following a spring-like path in the air in a precessional movement.

An advantage of searching for a satellite signal by way of a nutation operation is that it is easier to continuously track the communication of a fast moving low-orbit satellite. When a nutation operation is performed, there may occur directions with which the communication signal is weakened and directions with which the communication signal is strengthened. By rotating the antenna to such directions, it is possible to always keep the strength of the satellite communication great.

While the foregoing provides a description with reference to a preferred embodiment of the present invention, it should be appreciated that a person having ordinary skill in the relevant field of art would be able to make various modifications and alterations to the present invention without departing from the spirit and scope of the present invention set forth in the scope of claims below.

What is claimed is:

1. A satellite antenna having a function for excluding adjacent satellite interference, the satellite antenna comprising:
an antenna unit for receiving a signal from a satellite;
a signal-to-noise ratio (SNR) calculation unit configured to calculate a signal-to-noise ratio (SNR) for a satellite signal received by the antenna unit; and
a signal selection unit configured to compare signal-to-noise ratios calculated by the SNR calculation unit for satellite signals from a plurality of satellites and select one satellite signal.

2. The satellite antenna of claim 1, wherein the signal selection unit selects a satellite signal having a highest signal-to-noise ratio.

3. The satellite antenna of claim 2, further comprising:
a rotation control unit configured to control a direction of the antenna unit,
wherein the signal selection unit controls the rotation control unit to rotate the antenna unit if a result of comparing the signal-to-noise ratios yields a difference smaller than a threshold value.

4. The satellite antenna of claim 3, wherein the signal selection unit sequentially rotates the antenna unit in predetermined directions within a particular angle and ultimately selects a satellite signal having a highest signal-to-noise ratio with a difference greater than or equal to the threshold value.

5. The satellite antenna of claim 4, wherein the signal selection unit determines a sequence of the directions based on a target satellite aimed for detection and a predicted surrounding satellite.

6. The satellite antenna of claim 5, wherein the signal selection unit controls the rotation control unit to rotate the antenna unit again to a direction with which a signal strength of the selected satellite signal was strongest.

7. The satellite antenna of claim 4, wherein the threshold value is set in accordance with a highest signal-to-noise ratio value.

8. The satellite antenna of claim 1, wherein the antenna unit further comprises:
a directional antenna unit for receiving a satellite signal having a highest signal-to-noise ratio; and
an omnidirectional antenna unit for receiving signals including a plurality of satellite signals.

9. The satellite antenna of claim 8, wherein the antenna unit further comprises:
a noise generation unit configured to generate an ambient noise signal by subtracting a satellite signal received at the directional antenna unit from a surrounding signal including a satellite signal received at the omnidirectional antenna unit; and
a noise removal unit configured to generate a satellite signal with noise removed) by subtracting the ambient noise signal from the satellite signal received at the directional antenna unit.

10. An operating method of a function for excluding adjacent satellite interference, the operating method performed at a satellite antenna, the operating method comprising:
receiving satellite signals from a plurality of satellites;
calculating signal-to-noise ratios for the received satellite signals; and
selecting a satellite signal based on a comparison of the calculated signal-to-noise ratios.

11. The operating method of a function for excluding adjacent satellite interference according to claim 10, further comprising:
rotating an antenna if a comparison result of the signal-to-noise ratios yields a difference smaller than a threshold value.
